(19) United States
(12) Patent Application Publication
(10) Pub. No.: US 2011/0281469 A1
(43) Pub. Date: Nov. 17, 2011

(54) CABLE ASSEMBLY WITH IMPROVED TERMINATING MEANS

(75) Inventors: PING-SHENG SU, New Taipei (TW); XIAO-LI LI, Kunshan (CN)

(73) Assignee: HON HAI PRECISION INDUSTRY CO., LTD., New Taipei (TW)

(21) Appl. No.: 13/105,933

(22) Filed: May 12, 2011

(30) Foreign Application Priority Data
May 12, 2010 (CN) 201020187291.7

(51) Int. Cl. H01R 24/00

(52) U.S. Cl. 439/660

(57) ABSTRACT

A cable assembly includes an insulative housing (11); a cable (14) having an insulative jacket (143) and a one-piece wire group (141) enclosed by the insulative jacket, and the one piece wire group having a number of discrete inner conductors enclosed by an insulator; and a plurality of contacts (13) mounted to the insulative housing, and each of the contacts having a retention portion, a mating portion and a tail portion, the tail portion inserted into the wire group along an axial direction and contacting with the corresponding inner conductor.

### BACKGROUND OF THE INVENTION

1. Field of the Invention

The present invention relates to a cable assembly, especially to a cable assembly with improved terminating means. The application relates to the copending application Ser. No. 13/081,508 having the same inventors and the same assignee therewith.

2. Description of Related Art

A cable assembly generally refers to a cable connected to a connector. The connector includes an insulative housing, a plurality of contacts mounted to the insulative housing and a cable having a number of wires with inner conductors respectively soldered to the contacts.

However, there are some problems of terminating the wires to the contacts by soldering process. First, the cable should be trimmed, i.e. a front part of a jacket of the cable should be removed away to expose the wires, and then an insulator outside of the corresponding wire should be stripped off so as to expose the inner conductors outside, and then the wires also should be organized as they are always in a mess state. It takes much time to terminate the wires to the contacts by soldering process. In addition, the soldering process may cause environment pollution.

Hence, an improved means for terminating the wires to the contacts is required to overcome the problems of the prior art.

### SUMMARY OF THE INVENTION

An object of the present invention is to provide terminating means for a cable assembly without soldering process.

Accordingly, to achieve above-mentioned object, a cable assembly comprises an insulative housing; a cable having an insulative jacket and a one-piece wire group enclosed by the insulative jacket, and the one piece wire group having a number of discrete inner conductors enclosed by an insulator; and a plurality of contacts mounted to the insulative housing, and each of the contacts having a retention portion, a mating portion and a tail portion, the tail portion inserted into the wire group along an axial direction and contacting with the corresponding inner conductor.

The detailed features of the present invention will be apparent in the detailed description with appropriate reference to the accompanying drawings.

### BRIEF DESCRIPTION OF THE DRAWINGS

FIG. 1 is an assembled, perspective view of a cable assembly of in accordance with the present invention;

FIG. 2 is an exploded, perspective view of the cable assembly in FIG. 1;

FIG. 3 is similar to FIG. 2, but viewed from other aspect;

FIG. 4 shows relations between contacts and a cable; and

FIG. 5 is a cross-section view of the FIG. 1 taken along line 5-5.

### DETAILED DESCRIPTION OF THE INVENTION

Reference will now be made in detail to the preferred embodiment of the present invention.

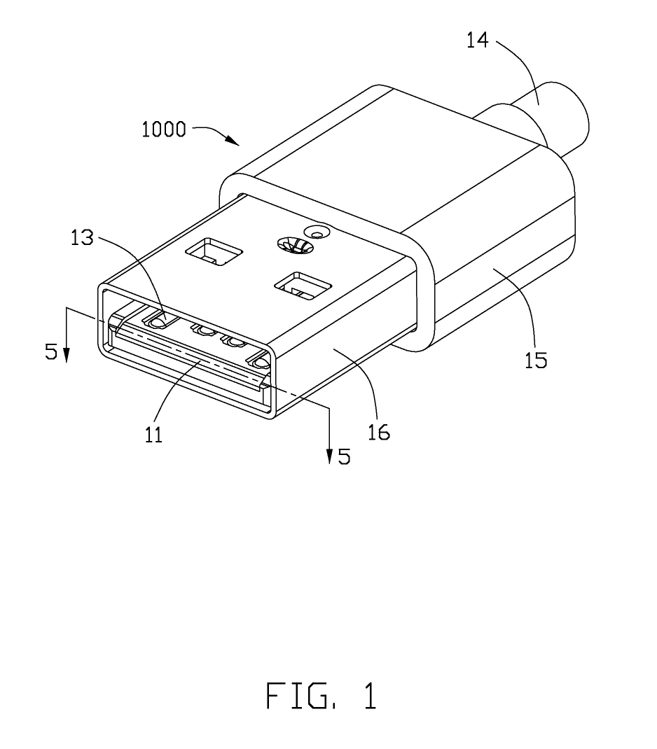

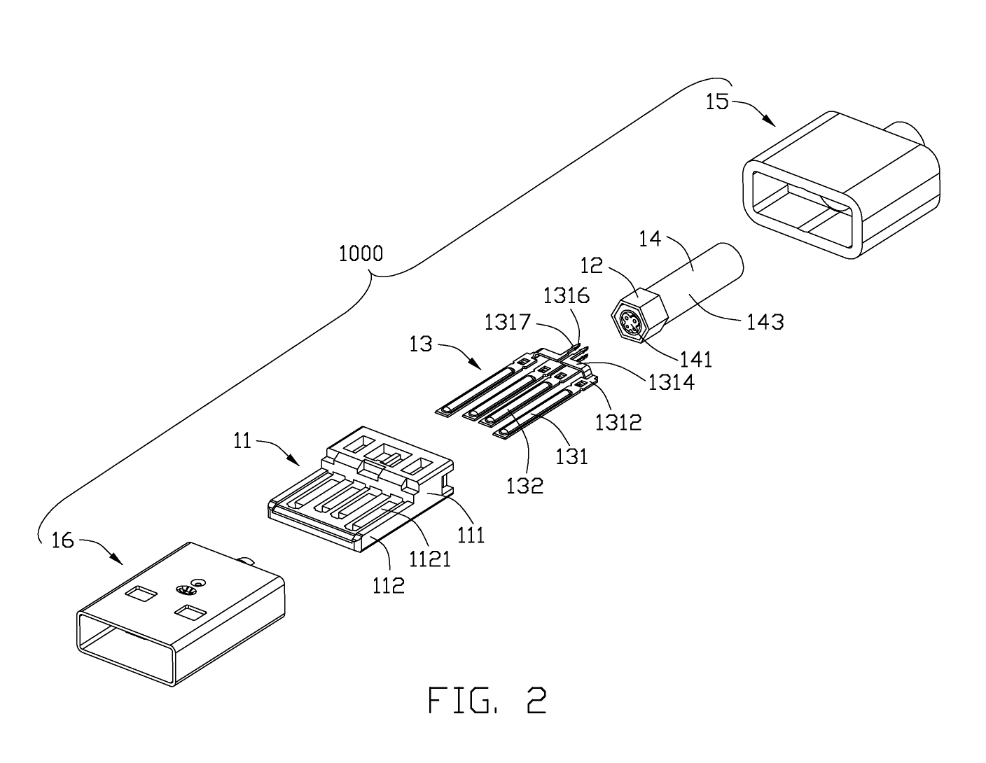

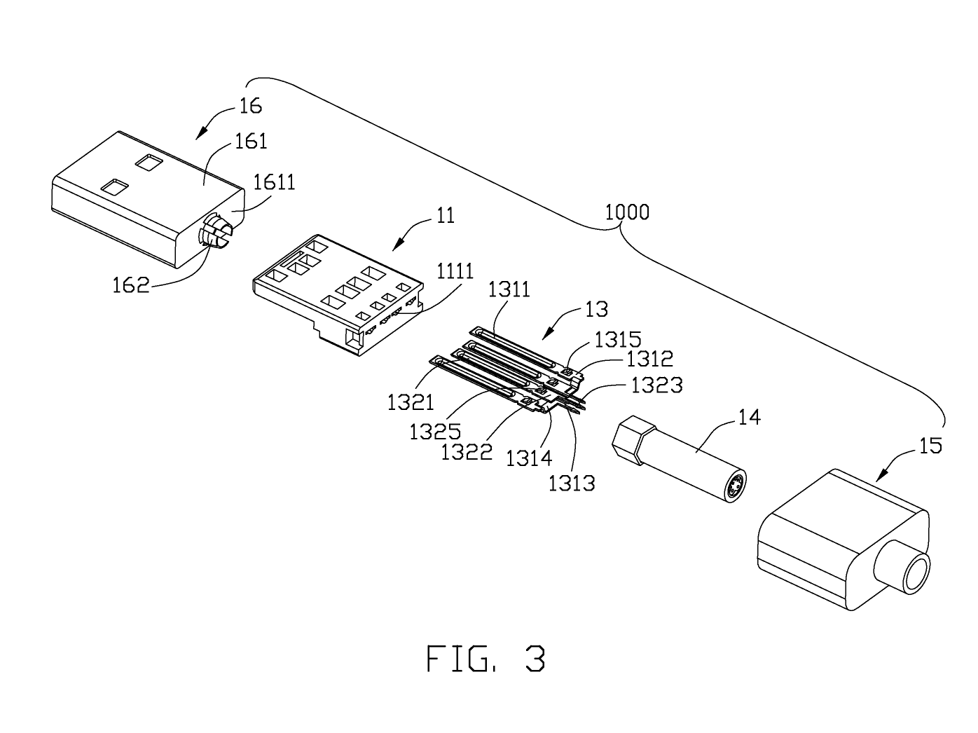

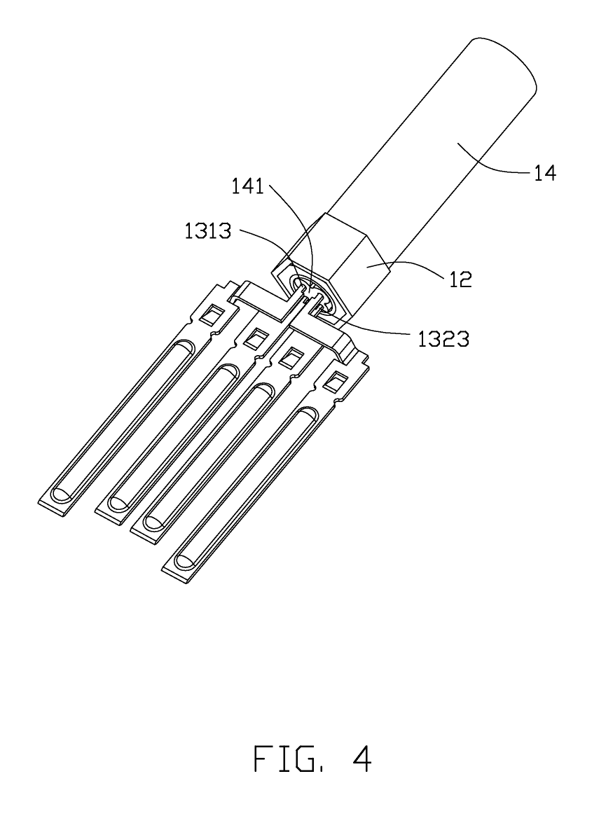

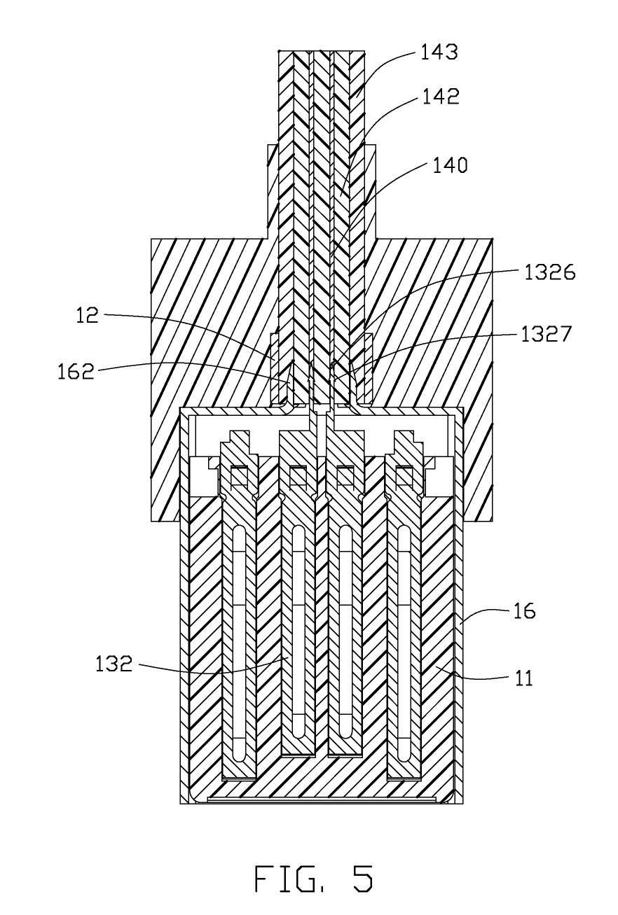

Referring to FIGS. 1-5, a cable assembly 1000 in accordance with the present invention is compatible with Universal Serial Bus (USB). The cable assembly 1000 includes an insulative housing 11, a ferrule 12, a plurality of contacts 13 supported by the insulative housing 11, a cable 14 electrically connected with the contacts 13, an insulative cover 15 and a metallic shell 16.

The insulative housing 11 has a base portion 111 and a tongue portion 112 extending forwardly from the base portion 111. The base portion 11 is thicker than the tongue portion 112. There are a number of slots 1111 defined in the base portion 111 and extending along a front-back-direction. Also, a number of grooves 1121 are located in a top side of the tongue portion 112 and align with the slots 1111, respectively. Both the slots 1111 and the grooves 1121 are arranged in a row along a transversal direction.

There are four contacts 13 in the embodiment. Two first contacts 131 are disposed at opposite sides and two second contacts 132 located between the two first contacts 131. Each first contact 131 has a retention portion 1312, a mating portion 1311 extending forwardly from the retention portion 1312, a L-shaped mediate portion 1314 raised from a back portion of the retention portion 1312 and extending inwardly therefrom, and a tail portion 1313 extending backwardly from an end of the mediate portion 1314. The tail portion 1313 has a tapered/sharp free end 1316. There are two tiny barbs 1317 respectively formed at opposite sides of the tail potion 1313 and located proximate to the tapered/sharp free end 1316. Each second contact 132 has a retention portion 1322, a mating portion 1321 extending forwardly from the retention portion 1322, and a tail portion 1323 extending backwardly from an end of the retention portion 1322. The tail portion 1323 has a tapered/sharp free end 1326. There are two tiny barbs 1327 respectively formed at opposite sides of the tail potion 1323 and located proximate to the tapered/sharp free end 1326. In addition, there is a retention tab 1315/1325 upwardly projects from the retention portion 1312/1322. Two tail portions 1313 of the two first contacts 131 are disposed adjacent to each other and arranged at a first level. Two tail portions 1323 of the two second contacts 132 are disposed adjacent to each other and arranged at a second level which is under the first level. A distance between the tail portions 1313 of the first contacts 131 is equal to a distance between the tail portions 1323 of the second contacts 132. Of course, the number of the first contacts 131 and the second contacts 132 may be more than two. By such arrangement, tail portions 1313/1323 are compact. The contacts 13 are assembled to the insulative housing 11 along a front-to-back direction, with the mating portion 1311/1321 accommodated in the corresponding groove 1121, the retention portion 1312/1322 inferentially received in the corresponding slot 1111, and the tail portion 1313/1323 disposed behind the base portion 111 of the insulative housing 11.

The cable 14 is a round type cable, which includes a wire group 141, an insulative jacket 143 enclosing the wire group 141. The wire group 141 is one-piece structure which including four discrete inner conductors 140 enclosed by only one insulator 142. The wire group 141 is manufactured by extruding process, with four inner conductors 140 and the insulator 142 combined together simultaneously. That is to say, the wire group 141 is a completely solid structure, and there is no any gap between the inner conductors 140 or there is no seam inside the wire group 141, which is different from common wire group with one inner conductor shield by a layer of insulator separated from another conductor shield by another layer of insulator. Therefore, the wire group 141 is compact and facilitating terminating with the contacts 13 by an axial IDC (Insulation Displacement Connection) technique.

The metallic shell 16 has a rectangular shaped frame portion 161 with a back wall 1611 and a cylindrical shaped extension portion 162 projecting backwardly from the back wall 1611.

When assembly, an one piece of insulator 142 is molded onto/over the discrete inner conductors 140 which extend along an axial direction so as to insulate the inner conductors 140 therebetween and the inner conductors 140 from an exterior along a radial direction perpendicular to the axial direction. The insulative housing 11 is mounted into the frame portion 161 and the tail portions 1313, 1323 are disposed in the extension portion 162, then by adjusting the cable 14 and having the wire group 141 aligning with the tail portions 1313/1323 along an axial direction, pushing the insulative housing 11 backwardly movement to let the tail portions 1313, 1323 insert/penetrate into the wire group 141 along the axial direction of the cable 14, thus the tail portions 1313, 1323 respectively contacting with the inner conductors 140 thereof to form electrical connection therebetween. The extension portion 162 is inserted into the insulative jacket 143. The ferrule 12 is mounted/crimped to an outside of the insulative jacket 143 to shrink the extension portion 162 so as to retain the tail portions 1313, 1323 and the wire group 141. Finally, the insulative cover 15 is molded over a back segment of the metallic shell 16, a front segment of the cable 14 and the ferrule 12. As the inner conductors 140 and the insulator 142 are formed of unitary structure, and it is easy and accurate for aligning with and terminating to the tail portions 1313, 1323.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A cable assembly, comprising:
an insulative housing;
a cable having an insulative jacket and a one-piece wire group enclosed by the insulative jacket, and the one piece wire group having a number of discrete inner conductors enclosed by an insulator; and
a plurality of contacts mounted to the insulative housing, and each of the contacts having a retention portion, a mating portion and a tail portion, the tail portion inserted into the wire group along an axial direction and contacting with the corresponding inner conductor.

2. The cable assembly as claimed in claim 1, wherein there are at least two tail portions of the contacts inserted into the insulator.

3. The cable assembly as claimed in claim 1, wherein the insulator fills into gaps between the inner conductors.

4. The cable assembly as claimed in claim 3, wherein the wire group is a solid structure and there is no seam therein.

5. The cable assembly as claimed in claim 1, wherein the insulator with the inner conductors are extruded simultaneously.

6. The cable assembly as claimed in claim 1, wherein there are two first contacts and two second contacts disposed between the two first contacts.

7. The cable assembly as claimed in claim 6, wherein the first contact further has a mediate portion connecting the retention portion and the tail portion.

8. The cable assembly as claimed in claim 7, wherein the mediate portion extends upwardly and inwardly from the retention portion.

9. The cable assembly as claimed in claim 5, wherein the mediate portion is L-shaped.

10. A cable assembly, comprising:
an insulative housing;
a cable having a number of discrete inner conductors extending along an axial direction and one piece of insulator molded onto the inner conductors to insulate the inner conductors therebetween and the inner conductors from an exterior along a radial direction perpendicular to the axial direction; and
a plurality of contacts mounted to the insulative housing, and each of the contacts having a retention portion, a mating portion and a tail portion, the tail portion inserted into the insulator along the axial direction and contacting with the corresponding inner conductor.

11. The cable assembly as claimed in claim 10, further comprising a metallic shell enclosing the insulative housing.

12. The cable assembly as claimed in claim 11, wherein the metallic shell includes a rectangular shaped frame portion enclosing the insulative housing and a cylindrical shaped extension portion projecting backwardly from the frame portion inserted into the insulative jacket.

13. The cable assembly as claimed in claim 12, wherein there is ferrule crimped to an outside of the insulative jacket to shrink the extension portion.

14. The cable assembly as claimed in claim 13, wherein there is an insulative cover molded over a back segment of the metallic shell, a front segment of the cable and the ferrule.

15. A cable connector assembly comprising:
an insulative housing defining a mating port on a front portion and a connection port on a rear portion along a front-to-back direction;
a plurality of contacts disposed in the housing, each of said contacts defining along said front-to-back direction a front contacting section exposed in the mating port and a rear connection section exposed in the mating port wherein said contacting sections are arranged in one row in a transverse direction perpendicular to said front-to-back direction while said connection sections are arranged in essentially a same circumference; and
a cable including a plurality of wires, each of which includes an inner conductor and an outer insulator, securely arranged in another same circumference in a cross-sectional view via unifying the outer insulator of each of said wires together so as to be in alignment with the connection sections of the corresponding contacts in the front-to-back direction and have the connection sections of said contacts axially inserted into the inner conductors of the corresponding wires, respectively.

16. The cable connector assembly as claimed in claim 15, wherein an amount of said contacts is four under condition that the connection sections are arranged as a four sided configuration, and an amount of wires is four under condition that a cross-section of said wires defines a cross-like configuration.

17. The cable connector assembly as claimed in claim 16, wherein said four contacts includes two signal contacts and one grounding contact and one power contact, under condition that a distance between the connection sections of said two signal contacts in the transverse direction is smaller than that between the connection sections of both said grounding contact and said power contact.

18. The cable connector assembly as claimed in claim 17, wherein the contacting sections of the two signal contacts are located between those of the power contact and the grounding contact while the connection sections of the signal contacts are located below those of the power contact and the grounding contact in a vertical direction perpendicular to both said front-to-back direction and said transverse direction.

19. The cable connector assembly as claimed in claim 18, wherein the connection section and the contacting section of each of the signal contacts are aligned with each other in the front-to-back direction while those of each of either power contact or grounding contact are offset from each other in both the vertical direction and the transverse direction.

20. The cable connector assembly as claimed in claim 16, wherein the wires include two signal wires, one power wire and one grounding wire, under condition that a distance between the inner conductors of the two signal wires is smaller than that between the inner conductors of both said power wire and said grounding wire.
